(19) United States
(12) Patent Application Publication
(10) Pub. No.: US 2024/0220408 A1
(43) Pub. Date: Jul. 4, 2024

(54) DYNAMIC ALLOCATION SCHEMES IN MEMORY SIDE CACHE FOR BANDWIDTH AND PERFORMANCE OPTIMIZATION

(71) Applicant: Intel Corporation, Santa Clara, CA (US)

(72) Inventors: Nadav Bonen, Ofer Z (IL); Israel Diamand, Aderet M (IL); Julius Mandelblat, Haifa (IL); Asaf Rubinstein, Kefar (IL); Igor Brainman, Kfar Saba M (IL)

(73) Assignee: Intel Corporation, Santa Clara, CA (US)

(21) Appl. No.: 18/089,782

(22) Filed: Dec. 28, 2022

(51) Int. Cl. G06F 12/0802

(52) U.S. Cl. CPC G06F 12/0802; G06F 2212/1016

(57) ABSTRACT

Methods and apparatus relating to dynamic allocation schemes applied to a memory side cache for bandwidth and/or performance optimization are described. In an embodiment, a memory side cache stores a portion of data to be stored in a main memory. Logic circuitry determines whether to allocate a portion of the memory side cache for use by a device. The remaining portion of the memory side cache is to be used by a processor. The allocated portion of the memory side cache is reallocated for use by the processor in response to a determination that the allocated portion of the memory side cache is no longer to be used by the device. Other embodiments are also disclosed and claimed.

### FIELD

The present disclosure generally relates to the field of processors. More particularly, some embodiments relate to dynamic allocation schemes applied to a memory side cache for bandwidth and performance optimization.

### BACKGROUND

To improve performance, most modern processors include on-chip cache memory. Generally, data stored in a cache is accessible by a processor many times faster than data stored in the main system memory or other more remote storage devices. However, cache allocation techniques may have a direct impact on overall system performance and/or power consumption, including for example performance and/or bandwidth efficiency.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of various components of a System-on-Chip (“SoC” or “SOC”), in accordance with an embodiment.

FIG. 2 illustrates a functional block diagram of a system to provide a dynamic allocation scheme, according to an embodiment.

FIG. 3 illustrates a sample Device Reservation Table (DRT), according to an embodiment.

FIG. 4 illustrates a flow diagram of a method for a dynamic allocation scheme applied to a memory side cache for bandwidth and performance optimization, according to an embodiment.

FIG. 5 illustrates an example computing system.

FIG. 6 illustrates a block diagram of an example processor and/or System on a Chip (SoC) that may have one or more cores and an integrated memory controller.

FIG. 7(A) is a block diagram illustrating both an example in-order pipeline and an example register renaming, out-of-order issue/execution pipeline according to examples.

FIG. 7(B) is a block diagram illustrating both an example in-order architecture core and an example register renaming, out-of-order issue/execution architecture core to be included in a processor according to examples.

FIG. 8 illustrates examples of execution unit(s) circuitry.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As discussed above, cache allocation techniques may have a direct impact on overall system performance and/or power consumption, including for example performance and/or bandwidth efficiency. Memory Side cache (MS$), also sometimes referred to as “system cache” is typically a small cache which funnels all traffic going to main memory (e.g., Dynamic Random Access Memory (DRAM)) in a computing device. MS$ may serve two main purposes: reduce bandwidth (e.g., for battery life) and improve processor performance.

Moreover, a blind (victim) cache allocation scheme generally improves processor performance through latency reduction while saving bandwidth. On the other hand, a processor may have a low hit rate in MS$ due to the unpredictability of the code, core local caches, and the relatively small size of MS$. Device traffic on the other hand is typically not latency sensitive but often would use well-defined buffers, which by selectively allocating them, may gain close to 100% hit rate and reduce bandwidth.

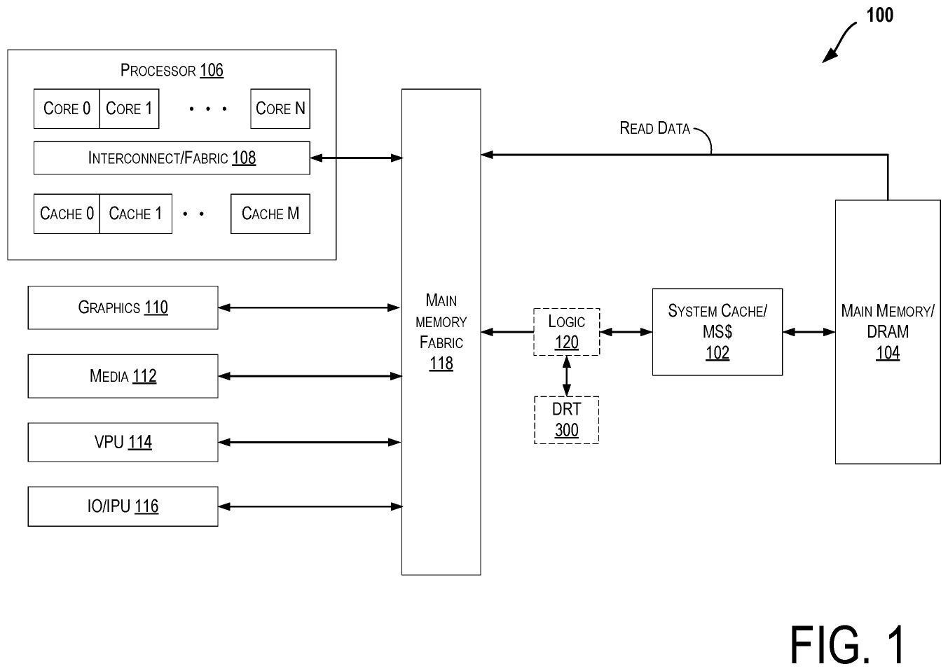

To this end, some embodiments provide dynamic allocation schemes in a memory side cache for bandwidth and/or performance optimization. Dynamic allocation schemes for memory side cache policies may improve battery life (“BL”) as a result of main memory/DRAM bandwidth reduction with minimal impact to processor performance. In an embodiment, a memory side cache (e.g., MS$102 of FIG. 1) stores a portion of data to be stored in a main memory. Logic circuitry (e.g., logic 120 of FIG. 1) determines whether to allocate a portion of the memory side cache for use by a device. The remaining portion of the memory side cache is to be used by a processor. The allocated portion of the memory side cache is reallocated for use by the processor in response to a determination that the allocated portion of the memory side cache is no longer to be used by the device.

FIG. 1 illustrates a block diagram of various components of a System-on-Chip (“SoC” or “SOC”) 100, in accordance with an embodiment. System Cache/MS$ 102 may provide excellent power and/or performance benefits for various SoC Intellectual Property (IP) blocks, e.g., by reducing the overall access latency to a main memory/DRAM 104.

As shown in FIG. 1, a processor 106 may include a plurality of processor cores (labeled as cores 0-N), a plurality of caches (labeled as cache 0-M), and an interconnect or fabric 108 (e.g., to communicatively couple various components of the processor 106, including for example the cores and the caches). Various types of caches may be used in the processor 106 such as further discussed herein with reference to the remaining figures, including, for example, shared caches (e.g., Last Level Cache (LLC)).

SoC 100 may also include one or of other IP blocks such as a graphics (GT) logic/block 110, media logic/block 112, Vision Processing Unit (VPU) 114, Input/Output (“IO” or “I/O”) logic/block 116 (such as an Infrastructure Processing Unit (IPU)), etc. As shown, the processor 106 and blocks 110-116 communicate with the main memory/DRAM 104 through a main memory fabric 118. While the main memory fabric 118 may receive read data from the main memory/DRAM 104, all traffic going to the main memory/DRAM 104 is transmitted via the system cache/MS$102.

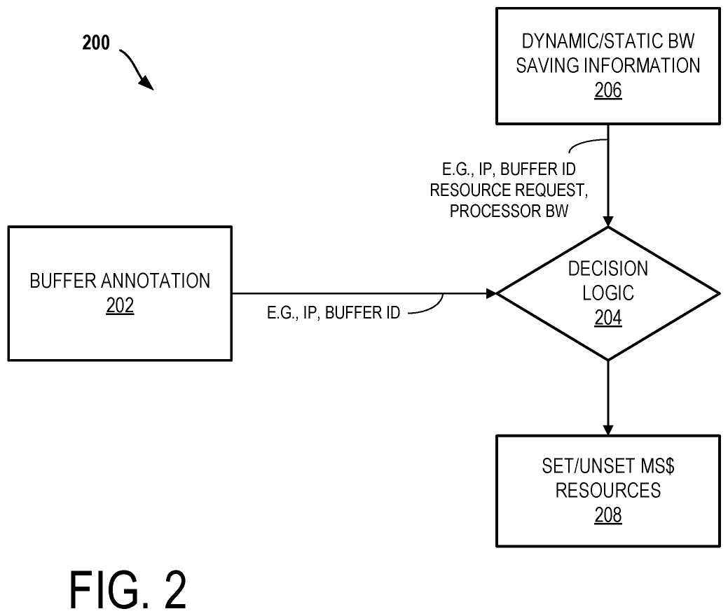

As will be discussed further herein, dynamic allocation logic 120 provides one or more dynamic allocation schemes for the system cache 102 to improve bandwidth and/or performance. In at least one embodiment, logic 120 may perform various task with reference to a Device Reservation Table (DRT) 300, as will be further discussed with reference to FIGS. 2-4. While logic 120 and DRT 300 are shown as separate blocks in FIG. 1, embodiments are not limited to this configuration and DRT 300 may be incorporated with logic 120, system cache 102 may incorporate one or both logic 120 and DRT 300, etc.

As mentioned before, dynamic allocation schemes for memory side cache policies may improve battery life as a result of DRAM bandwidth reduction with minimal impact to processor performance. In one or more embodiments, this may be implemented by one or more of: (1) allowing processor traffic to use a victim cache allocation scheme (e.g., write operations would allocate in MS$ unless another scheme such as Dead Block Prediction (DBP) requires otherwise); (2) device traffic is not allocated in MS$ except predefined in reserved buffers (e.g., that have high-bandwidth and/or low footprint); and/or (3) a dynamic device allocation scheme assigns (e.g., isolates) certain system cache space to the device buffers and reclaims the space for processor usage once a device is done using the allocated space.

As discussed herein, DBP may implement selective bypassing of certain cachelines in a Last Level Cache (LLC) by marking the Middle Level Cache (MLC) cacheline evictions as dead, where the marked cachelines have a low probability of re-use from the LLC.

Further, processor write traffic is typically allocated in the cache blindly (e.g., for every write operation) or per a DBP scheme. Read operations hitting allocated cachelines reduce main memory/DRAM bandwidth access and provide reduced latency which contributes to performance. Due to the random nature of processor traffic (e.g., due to execution of different software, branches etc. as well as processor caching systems), the hit rate (or the percentage of read operations hitting in the cache) for a small cache can be fairly low (e.g., approximately 30%). Device traffic, on the other hand, is typically not latency sensitive but often uses well-defined buffers which, by selectively allocating them, may gain close to 100% hit rate and reduce more bandwidth than a processor.

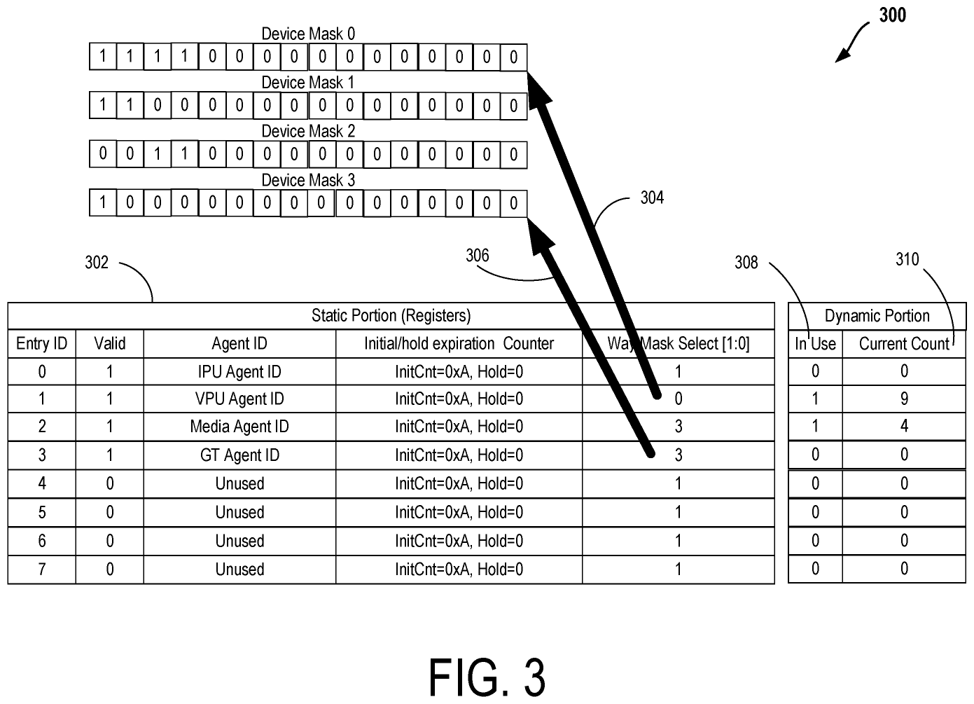

In one embodiment, in order to gain from processor bandwidth and performance while leveraging the predictability of device buffers, a dynamic scheme assigns (e.g., isolates) certain cache space in the MS$102 to one or more device buffers and reclaims this cache space for the processor usage once the device is done using the assigned cache space or some timer (e.g., indicting non-use) has expired. Various techniques may be used to determine whether a device is done using its assigned buffer including, for example, per some counter value (see, e.g., the discussion of FIG. 3), per a signal sent to indicate the device is no longer is in need of the buffer (e.g., the device is powered down, removed, the signal is proactively sent by a system component (e.g., the device) to indicate no further use of the buffer is needed, etc.).

FIG. 2 illustrates a functional block diagram of a system 200 to provide a dynamic allocation scheme, according to an embodiment. One or more of the operations of the system 200 may be performed by one or more components discussed with reference to FIG. 1, such as the dynamic allocation logic 120 and/or DRT 300 as will be more specifically discussed below.

Referring to FIGS. 1 and 2, at an operation 202, a buffer annotation scheme (e.g., using an IP block or logic) is used to deliver information/request to a decision logic 204 about one or more device buffers to be allocated in order to request/reserve resources in the MS$102. In some embodiments, the buffer information/request includes a resource type and size. The requested resource types may include: don't allocate, allocate in global cache pool, and/or allocate in a reserved pool.

In an embodiment, the request for cache resource type is transmitted from the IP block 202 on each memory transaction. In another embodiment, a request message at the beginning or end of a buffer access may be used (e.g., a device driver sends a message from the processor via the IP hardware 202). In the latter case, a buffer capacity/size may also be requested. In either case, the actual allocation and capacity may be determined at the allocation decision 204.

In one embodiment, the buffer annotation at 202 may originate at compile time. The IP logic 202 may detect the buffer on its outgoing memory transactions and attach an identifier (ID) or request type to an outgoing memory transaction. In some IP blocks, the buffer type may be determined by hardware only (e.g., for the media block 112). Further, in case of multiple contexts using the same buffer type, the IP block logic/firmware may determine which contexts may request allocation (e.g., for the VPU block 114).

At block 204 (e.g. performed by logic 120), the allocation decision is made based on the information received from the IP block 202 as well as from saved dynamic/static bandwidth (BW) information 206 (which may include information about an IP block requesting a buffer, buffer ID resource request, processor bandwidth information, etc.). As a processor benefits for both power consumption (e.g., reduced bandwidth usage) and performance (e.g., reduced latency) when using a cache, allocating resources to devices may be done only if there is a substantial/sizable battery life improvement. Hence, the decision logic at 204 may determine whether allocating cache resources to a certain device buffer would result in a better bandwidth saving than using the resources for a processor. Moreover, processor bandwidth saving depends on the current processor bandwidth and cache hit rate. Device bandwidth saving may depend on buffer bandwidth, its required footprint, and residency. Since the buffer and usage are well-defined, its hit rate may be close to 100%.

This high hit rate can require separation of device resources from processor resources to prevent high bandwidth, low hit rate processor traffic from flushing it. To compare a device bandwidth against a processor bandwidth saving per cache resource (e.g., in Mega Byte (MB)), a Normalized Bandwidth Saving (NBS) metric may be defined and utilized in some embodiments, as further discussed below. At block 208, an allocation controller (e.g., logic 120) allocates/deallocates space in the MS$102, e.g., by setting/unsetting MS$ resources.

In various embodiments, several decision schemes may be considered at block 204 (e.g., based on the device driver, firmware, hardware, etc.). In an embodiment, a hardware based decision scheme may be used to provide a highly responsive solution. For example, logic 120 may calculate offline the NBS for all device buffers of all internal devices (e.g., in an SoC such as the SoC 100), configure device compilers to request resource for buffers with very high NBS. In an embodiment, a central logic (e.g., logic 120) allocates such resources in a mode (e.g., battery life mode) when the processor is not performing critical tasks. In another embodiment, a decision scheme can be used where device buffers' NBS would be compared against current processor' NBS using a processor bandwidth meter.

In one embodiment, the MS$ resource capacity/size per device buffer may be registered by a configuration table such as DRT 300 of FIG. 3. To prevent oversubscription, a limit may be set for the overall reserved device capacity that may be taken and the capacity usage may be tracked via a device capacity register/counter (e.g., current count 310 of FIG. 3). Alternatively, an embodiment utilizes the current count 310 as a time counter, e.g., indicating how much time is left since the last request from the device.

In an embodiment, the above decision scheme can be described using the following pseudo code for an incoming transaction:

$$If SoC . BL\_mode == DC AND buffer\_request \_type == reserved allocation \{ Lookup ( IP [ x ] . buffer [ y ] ) in DRT table to get Buffer\_NBS , Buffer\_capactiy If Buffer\_NBS > processor\_NBS * factor AND Buffer\_Capacity < ramaining\_device \_capacity \to reserve buffer for IP [ x ] . buffer [ y ] , remaining\_device \_capacity -= Buffer\_Capacity \}$$

In another embodiment, the expression “Buffer_NBS>processor_NBS*factor” is precalculated by the device logic (and not checked in real time by decision logic 204), as a part of the decision to set the buffer_request_type, e.g., if it is known that this device has a buffer for which the NBS is better than a typical processor NBS, the request attribute is set to allocate on reserved space. In addition, on run time, if it is known that currently all processors are in sleep state, all the processor's space may be freed for devices, and then the space may be used also for device request that asks to allocate in non-reserved buffers.

In the above pseudo code, “DC” refers to enabled or selected, “factor” refers to some value to adjust for processor NBS variations (e.g., based on the type of processor, number of active processor cores, criticality of processor performance, etc.), and “remaining_device_capacity” refers to the amount of space available in the MS$ prior to the requested allocation. Other terms used in the above pseudo code are descriptive and easily understood by those with ordinary skill in the art.

In an embodiment, the reservation (e.g., at block 208 of FIG. 2) is released to the processor pool after Texp time of no access to this buffer (e.g., as determined by reference to DRT 300). Texp may be defined per the buffer in DRT 300 and range from some fractions of milliseconds to several milliseconds in some implementations. Remaining device capacity may then be incremented with the freed buffer capacity. In one embodiment, the buffer capacity limitation is managed by masks as can be seen in the DRT description below with reference to FIG. 3.

In an embodiment, the decision logic 204 may decide to allocate the buffer in a global pool which is shared with the processor. This may be done in cases where the reserved space is full or when the processor traffic is determined to be low when compared with a threshold value.

In some embodiments, the method by which the reserved space in the MS$102 is allocated may be performed via Class of Service (CLoS) methodology. For example, a cache may generally be organized by sets and ways. Incoming cacheline allocation would then go to a specific set using its low address bits and data is stored in one of the ways along with its high address bits. The “way” may be chosen using a Least Recently Used (LRU) algorithm. In the embodiment with CLoS using ways masking, some of the ways can be assigned to a particular traffic class, e.g., buffer type. Other traffic would not allocate in the ways assigned to this CLoS, but the read lookup may be done across all ways. Different buffers requiring reserved space may share the same ways for associativity. For example, where each way is about 0.5 MB in size, a first buffer may request 1 MB (2 ways), a second buffer may request 2 MB (4 ways), and so on. To accommodate this, the reserved space may be increased from two to six ways, so both of these buffers would enjoy better associativity.

Further, during buffer deallocation, the CLoS mask may be removed so fewer ways are reserved. While the allocations in the removed ways may remain, some of the data may belong to an active buffer and, in time, part of it would be flushed by the processor before the buffer is done. Since buffers usually do not allocate in synchronization, it may be assumed that each buffer will utilize most of its ways so a small portion of other buffers would become unprotected. The associativity gain benefits can be considered to be more than this loss in some implementations.

Moreover, FIG. 3 illustrates a sample Device Reservation Table (DRT) 300, according to an embodiment. The main table 302 contains an entry per buffer, e.g., with an entry ID, valid bit per entry ID, Agent ID (e.g., to identifying which agent has sent the memory request, e.g., to distinguish it from the other agents), initial/hold expiration, way mask selected, in use bit, and a current count.

In an embodiment, each entry is associated with device mask (304/306). Moreover, as described above, traffic with reservation requests lookup the buffer, set the In Use bit 308 and initialize the counter 310. Reserved transactions may allocate any one of the ways currently in use (e.g., in use masks are logically ORed to form the reserved ways). A global counter may then decrement the “current count” of in use entries. When the counter reaches zero, an entry is no longer in use.

As mentioned above, dynamic allocation schemes for memory side cache policies may improve battery life as a result of main memory/DRAM bandwidth reduction with minimal impact to processor performance. For example, for a Teams® one-on-one session gains may be approximately 40 milli Watts (mW) or approximately five percent of a power budget.

### Normalized Bandwidth Saving (Nbs)

To determine whether more bandwidth gain can be achieved from a device buffer vs. a processor buffer, an embodiment defines a term called Normalized Bandwidth Saving (NBS). NBS is the bandwidth saved and normalized to 1 MB of cache.

If a certain device buffer NBS is higher than the processor NBS, the device buffer would save more bandwidth and therefore is considered for allocation. Since some embodiments dynamically allocate and deallocate cache resource for such buffers, device NBS has a residency factor as follows:

$$NBS = \frac{{BW}_{saved} * {1}_{MB}}{{footprint}_{MB} * residency}$$

For example, if MS$ is 8 MB and processor generate 2 Giga Bytes per second (GB/s) at 30% hit rate, the approximate processor NBS=2 GB/s*30%*1 MB/8 MB or 75 MB per second (MB/s) per 1 MB of cache. Also, this function may not be linear as hit rate generally drops with less cache, but this function provides a reasonably good approximation metric.

For a device processing a frame, reading a 2 MB buffer at 600 MB/s and buffer residency of 10% of frame time:

$$N B S = \frac{600 \frac{M B}{S} * {1}_{M B}}{2 M B * 10 \%} = 3 \frac{G B}{S} per MB of cache$$

Further, another way to consider residency here is to observe what happens during the 10% of time the device buffer is active, e.g., processor would save 7.5 MB/s per MB of cache while device would save 300 MB/s.

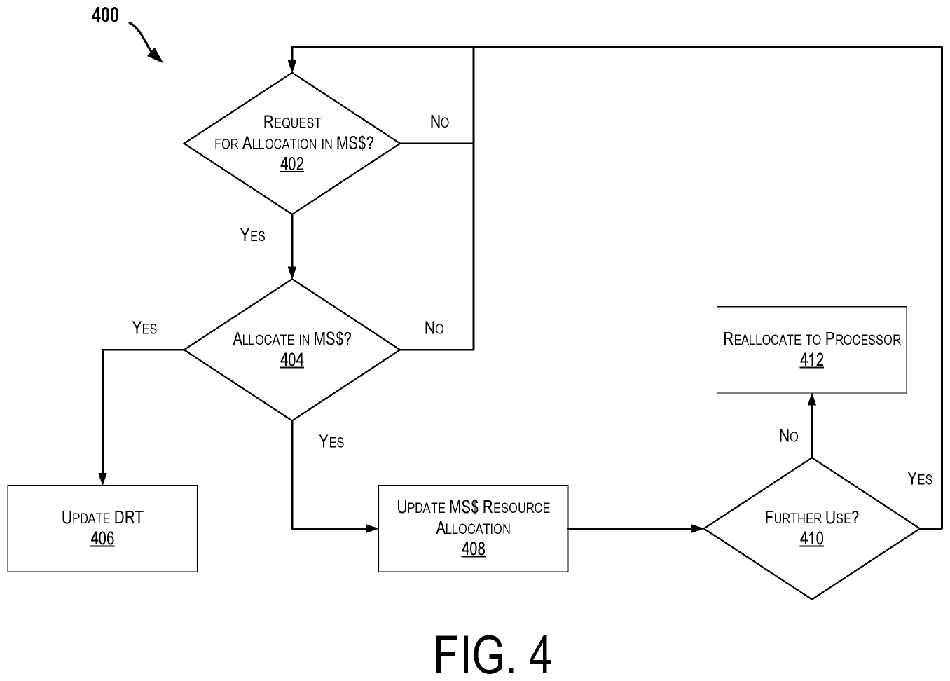

FIG. 4 illustrates a flow diagram of a method 400 for a dynamic allocation scheme applied to a memory side cache for bandwidth and performance optimization, according to an embodiment. In one embodiment, all operations of method 400 are performed by the logic 120 of FIG. 1.

Referring to FIGS. 1-4, at an operation 402, it is determined whether a request for allocation in an MS$ is received. Once received, an operation 404 determines whether to allocate one or more buffers in the MS$ (see, e.g., the discussion of FIGS. 2 and 3). If an allocation is to occur per operation 404, operations 406 and 408 are performed (e.g., performed either simultaneously or sequentially by logic 120), to update a DRT (such as DRT 300 of FIG. 3) and update allocation status of one or more portions of the MS$ (such as MS$102). At an operation 410, it is determined whether the allocated portion of the memory side cache is no longer to be used by the device. If no further use is planned (e.g., once the device is done using the assigned cache space or expiration of a timer as detailed above), an operation 412 reallocates the allocated portion of the memory side cache for use by the processor.

Accordingly, one or more embodiments aim to maximize system bandwidth reduction with minimal impact to processor performance by leveraging techniques that utilize memory side cache.

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

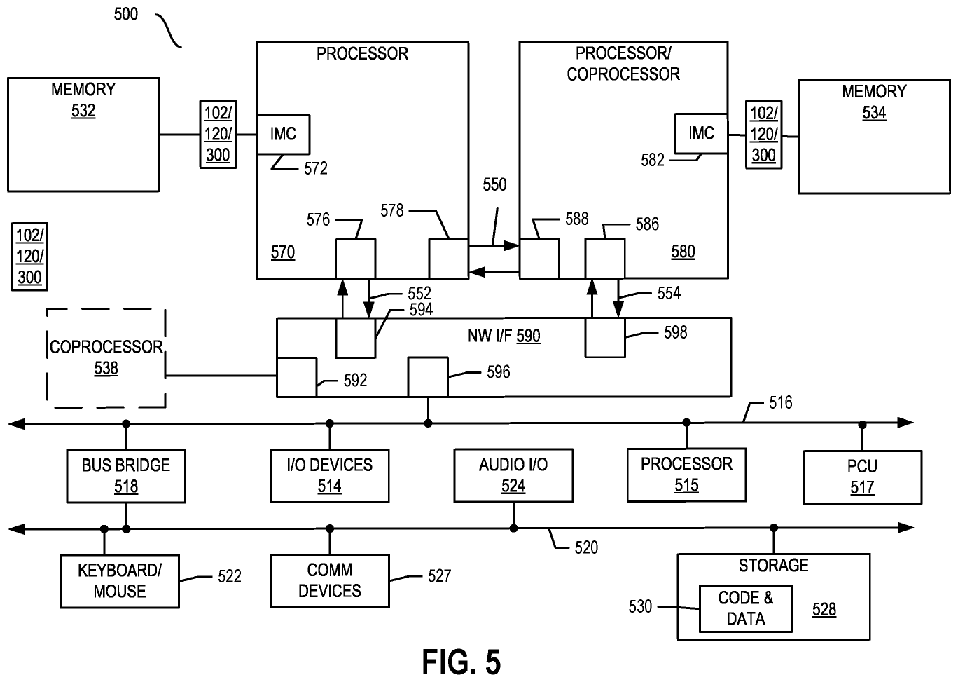

FIG. 5 illustrates an example computing system. Multiprocessor system 500 is an interfaced system and includes a plurality of processors or cores including a first processor 570 and a second processor 580 coupled via an interface 550 such as a point-to-point (P-P) interconnect, a fabric, and/or bus. In some examples, the first processor 570 and the second processor 580 are homogeneous. In some examples, first processor 570 and the second processor 580 are heterogenous. Though the example system 500 is shown to have two processors, the system may have three or more processors, or may be a single processor system. In some examples, the computing system is a system on a chip (SoC).

Processors 570 and 580 are shown including integrated memory controller (IMC) circuitry 572 and 582, respectively. Processor 570 also includes interface circuits 576 and 578; similarly, second processor 580 includes interface circuits 586 and 588. Processors 570, 580 may exchange information via the interface 550 using interface circuits 578, 588. IMCs 572 and 582 couple the processors 570, 580 to respective memories, namely a memory 532 and a memory 534, which may be portions of main memory locally attached to the respective processors.

Processors 570, 580 may each exchange information with a network interface (NW I/F) 590 via individual interfaces 552, 554 using interface circuits 576, 594, 586, 598. The network interface 590 (e.g., one or more of an interconnect, bus, and/or fabric, and in some examples is a chipset) may optionally exchange information with a coprocessor 538 via an interface circuit 592. In some examples, the coprocessor 538 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 570, 580 or outside of both processors, yet connected with the processors via an interface such as P-P interconnect, such that either or both processors' local cache information may be stored in the shared cache if a processor is placed into a low power mode.

Network interface 590 may be coupled to a first interface 516 via interface circuit 596. In some examples, first interface 516 may be an interface such as a Peripheral Component Interconnect (PCI) interconnect, a PCI Express interconnect or another I/O interconnect. In some examples, first interface 516 is coupled to a power control unit (PCU) 517, which may include circuitry, software, and/or firmware to perform power management operations with regard to the processors 570, 580 and/or co-processor 538. PCU 517 provides control information to a voltage regulator (not shown) to cause the voltage regulator to generate the appropriate regulated voltage. PCU 517 also provides control information to control the operating voltage generated. In various examples, PCU 517 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 517 is illustrated as being present as logic separate from the processor 570 and/or processor 580. In other cases, PCU 517 may execute on a given one or more of cores (not shown) of processor 570 or 580. In some cases, PCU 517 may be implemented as a microcontroller (dedicated or general-purpose) or other control logic configured to execute its own dedicated power management code, sometimes referred to as P-code. In yet other examples, power management operations to be performed by PCU 517 may be implemented externally to a processor, such as by way of a separate power management integrated circuit (PMIC) or another component external to the processor. In yet other examples, power management operations to be performed by PCU 517 may be implemented within BIOS or other system software.

Various I/O devices 514 may be coupled to first interface 516, along with a bus bridge 518 which couples first interface 516 to a second interface 520. In some examples, one or more additional processor(s) 515, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 516. In some examples, second interface 520 may be a low pin count (LPC) interface. Various devices may be coupled to second interface 520 including, for example, a keyboard and/or mouse 522, communication devices 527 and storage circuitry 528. Storage circuitry 528 may be one or more non-transitory machine-readable storage media as described below, such as a disk drive or other mass storage device which may include instructions/code and data 530 and may implement the storage ISAB03 in some examples. Further, an audio I/O 524 may be coupled to second interface 520. Note that other architectures than the point-to-point architecture described above are possible. For example, instead of the point-to-point architecture, a system such as multiprocessor system 500 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

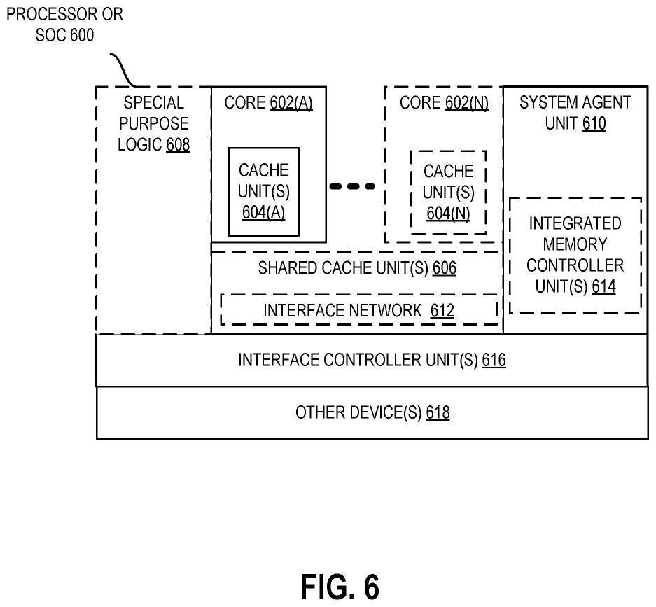

FIG. 6 illustrates a block diagram of an example processor and/or SoC 600 that may have one or more cores and an integrated memory controller. The solid lined boxes illustrate a processor 600 with a single core 602(A), system agent unit circuitry 610, and a set of one or more interface controller unit(s) circuitry 616, while the optional addition of the dashed lined boxes illustrates an alternative processor 600 with multiple cores 602(A)-(N), a set of one or more integrated memory controller unit(s) circuitry 614 in the system agent unit circuitry 610, and special purpose logic 608, as well as a set of one or more interface controller units circuitry 616. Note that the processor 600 may be one of the processors 570 or 580, or co-processor 538 or 515 of FIG. 5.

Thus, different implementations of the processor 600 may include: 1) a CPU with the special purpose logic 608 being integrated graphics and/or scientific (throughput) logic (which may include one or more cores, not shown), and the cores 602(A)-(N) being one or more general purpose cores (e.g., general purpose in-order cores, general purpose out-of-order cores, or a combination of the two); 2) a coprocessor with the cores 602(A)-(N) being a large number of special purpose cores intended primarily for graphics and/or scientific (throughput); and 3) a coprocessor with the cores 602(A)-(N) being a large number of general purpose in-order cores. Thus, the processor 600 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 604(A)-(N) within the cores 602(A)-(N), a set of one or more shared cache unit(s) circuitry 606, and external memory (not shown) coupled to the set of integrated memory controller unit(s) circuitry 614. The set of one or more shared cache unit(s) circuitry 606 may include one or more mid-level caches, such as level 2 (L2), level 3 (L3), level 4 (L4), or other levels of cache, such as a last level cache (LLC), and/or combinations thereof. While in some examples interface network circuitry 612 (e.g., a ring interconnect) interfaces the special purpose logic 608 (e.g., integrated graphics logic), the set of shared cache unit(s) circuitry 606, and the system agent unit circuitry 610, alternative examples use any number of well-known techniques for interfacing such units. In some examples, coherency is maintained between one or more of the shared cache unit(s) circuitry 606 and cores 602(A)-(N). In some examples, interface controller units circuitry 616 couple the cores 602 to one or more other devices 618 such as one or more I/O devices, storage, one or more communication devices (e.g., wireless networking, wired networking, etc.), etc.

In some examples, one or more of the cores 602(A)-(N) are capable of multi-threading. The system agent unit circuitry 610 includes those components coordinating and operating cores 602(A)-(N). The system agent unit circuitry 610 may include, for example, power control unit (PCU) circuitry and/or display unit circuitry (not shown). The PCU may be or may include logic and components needed for regulating the power state of the cores 602(A)-(N) and/or the special purpose logic 608 (e.g., integrated graphics logic). The display unit circuitry is for driving one or more externally connected displays.

The cores 602(A)-(N) may be homogenous in terms of instruction set architecture (ISA). Alternatively, the cores 602(A)-(N) may be heterogeneous in terms of ISA; that is, a subset of the cores 602(A)-(N) may be capable of executing an ISA, while other cores may be capable of executing only a subset of that ISA or another ISA.

### Example Core Architectures—In-Order and Out-of-Order Core Block Diagram

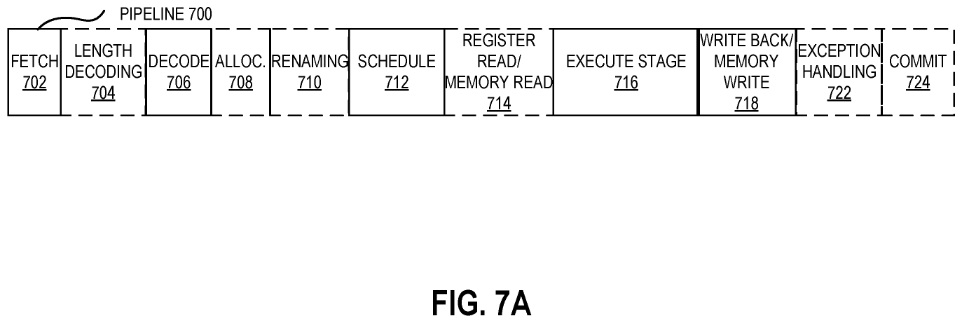

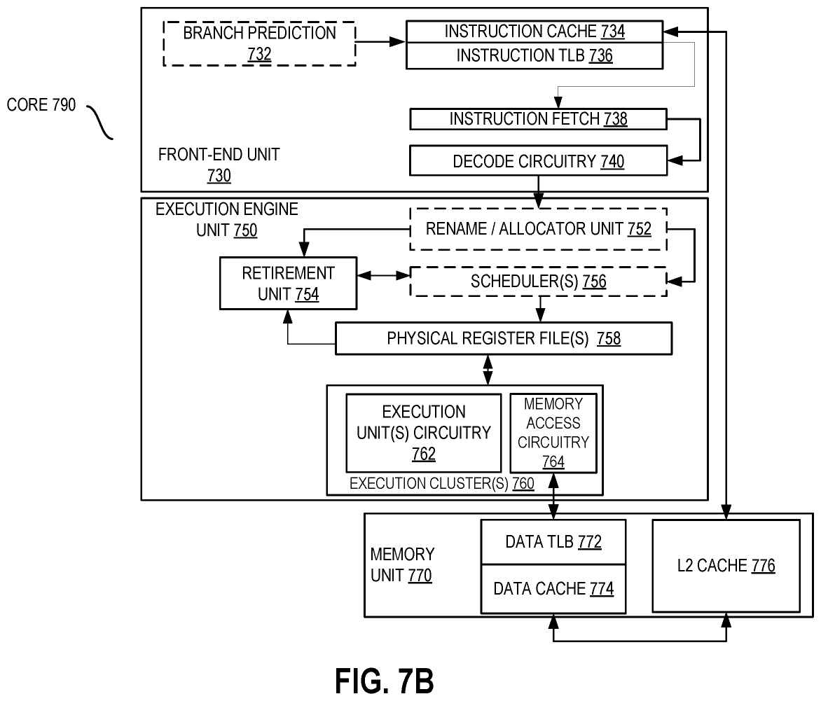

FIG. 7(A) is a block diagram illustrating both an example in-order pipeline and an example register renaming, out-of-order issue/execution pipeline according to examples. FIG. 7(B) is a block diagram illustrating both an example in-order architecture core and an example register renaming, out-of-order issue/execution architecture core to be included in a processor according to examples. The solid lined boxes in FIGS. 7(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7(A), a processor pipeline 700 includes a fetch stage 702, an optional length decoding stage 704, a decode stage 706, an optional allocation (Alloc) stage 708, an optional renaming stage 710, a schedule (also known as a dispatch or issue) stage 712, an optional register read/memory read stage 714, an execute stage 716, a write back/memory write stage 718, an optional exception handling stage 722, and an optional commit stage 724. One or more operations can be performed in each of these processor pipeline stages. For example, during the fetch stage 702, one or more instructions are fetched from instruction memory, and during the decode stage 706, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 706 and the register read/memory read stage 714 may be combined into one pipeline stage. In one example, during the execute stage 716, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 7(B) may implement the pipeline 700 as follows: 1) the instruction fetch circuitry 738 performs the fetch and length decoding stages 702 and 704; 2) the decode circuitry 740 performs the decode stage 706; 3) the rename/allocator unit circuitry 752 performs the allocation stage 708 and renaming stage 710; 4) the scheduler(s) circuitry 756 performs the schedule stage 712; 5) the physical register file(s) circuitry 758 and the memory unit circuitry 770 perform the register read/memory read stage 714; the execution cluster(s) 760 perform the execute stage 716; 6) the memory unit circuitry 770 and the physical register file(s) circuitry 758 perform the write back/memory write stage 718; 7) various circuitry may be involved in the exception handling stage 722; and 8) the retirement unit circuitry 754 and the physical register file(s) circuitry 758 perform the commit stage 724.

FIG. 7(B) shows a processor core 790 including front-end unit circuitry 730 coupled to execution engine unit circuitry 750, and both are coupled to memory unit circuitry 770. The core 790 may be a reduced instruction set architecture computing (RISC) core, a complex instruction set architecture computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front-end unit circuitry 730 may include branch prediction circuitry 732 coupled to instruction cache circuitry 734, which is coupled to an instruction translation lookaside buffer (TLB) 736, which is coupled to instruction fetch circuitry 738, which is coupled to decode circuitry 740. In one example, the instruction cache circuitry 734 is included in the memory unit circuitry 770 rather than the front-end circuitry 730. The decode circuitry 740 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 740 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 740 may be implemented using various different mechanisms. Examples of suitable mechanisms include, but are not limited to, look-up tables, hardware implementations, programmable logic arrays (PLAs), microcode read only memories (ROMs), etc. In one example, the core 790 includes a microcode ROM (not shown) or other medium that stores microcode for certain macroinstructions (e.g., in decode circuitry 740 or otherwise within the front-end circuitry 730). In one example, the decode circuitry 740 includes a micro-operation (micro-op) or operation cache (not shown) to hold/cache decoded operations, micro-tags, or micro-operations generated during the decode or other stages of the processor pipeline 700. The decode circuitry 740 may be coupled to rename/allocator unit circuitry 752 in the execution engine circuitry 750.

The execution engine circuitry 750 includes the rename/allocator unit circuitry 752 coupled to retirement unit circuitry 754 and a set of one or more scheduler(s) circuitry 756. The scheduler(s) circuitry 756 represents any number of different schedulers, including reservations stations, central instruction window, etc. In some examples, the scheduler(s) circuitry 756 can include arithmetic logic unit (ALU) scheduler/scheduling circuitry, ALU queues, address generation unit (AGU) scheduler/scheduling circuitry, AGU queues, etc. The scheduler(s) circuitry 756 is coupled to the physical register file(s) circuitry 758. Each of the physical register file(s) circuitry 758 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 758 includes vector registers unit circuitry, writemask registers unit circuitry, and scalar register unit circuitry. These register units may provide architectural vector registers, vector mask registers, general-purpose registers, etc. The physical register file(s) circuitry 758 is coupled to the retirement unit circuitry 754 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 754 and the physical register file(s) circuitry 758 are coupled to the execution cluster(s) 760. The execution cluster(s) 760 includes a set of one or more execution unit(s) circuitry 762 and a set of one or more memory access circuitry 764. The execution unit(s) circuitry 762 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 756, physical register file(s) circuitry 758, and execution cluster(s) 760 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 764). It should also be understood that where separate pipelines are used, one or more of these pipelines may be out-of-order issue/execution and the rest in-order.

In some examples, the execution engine unit circuitry 750 may perform load store unit (LSU) address/data pipelining to an Advanced Microcontroller Bus (AMB) interface (not shown), and address phase and writeback, data phase load, store, and branches.

The set of memory access circuitry 764 is coupled to the memory unit circuitry 770, which includes data TLB circuitry 772 coupled to data cache circuitry 774 coupled to level 2 (L2) cache circuitry 776. In one example, the memory access circuitry 764 may include load unit circuitry, store address unit circuitry, and store data unit circuitry, each of which is coupled to the data TLB circuitry 772 in the memory unit circuitry 770. The instruction cache circuitry 734 is further coupled to the level 2 (L2) cache circuitry 776 in the memory unit circuitry 770. In one example, the instruction cache 734 and the data cache 774 are combined into a single instruction and data cache (not shown) in L2 cache circuitry 776, level 3 (L3) cache circuitry (not shown), and/or main memory. The L2 cache circuitry 776 is coupled to one or more other levels of cache and eventually to a main memory.

The core 790 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 790 includes logic to support a packed data instruction set architecture extension (e.g., AVX1, AVX2), thereby allowing the operations used by many multimedia applications to be performed using packed data.

### Example Execution Unit(s) Circuitry

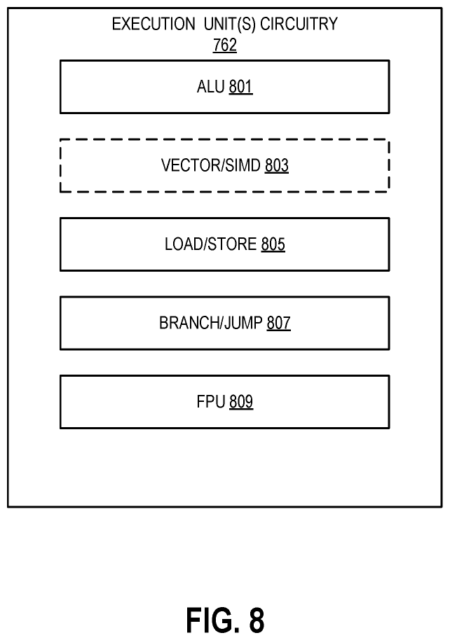

FIG. 8 illustrates examples of execution unit(s) circuitry, such as execution unit(s) circuitry 762 of FIG. 7(B). As illustrated, execution unit(s) circuitry 762 may include one or more ALU circuits 801, optional vector/single instruction multiple data (SIMD) circuits 803, load/store circuits 805, branch/jump circuits 807, and/or Floating-point unit (FPU) circuits 809. ALU circuits 801 perform integer arithmetic and/or Boolean operations. Vector/SIMD circuits 803 perform vector/SIMD operations on packed data (such as SIMD/vector registers). Load/store circuits 805 execute load and store instructions to load data from memory into registers or store from registers to memory. Load/store circuits 805 may also generate addresses. Branch/jump circuits 807 cause a branch or jump to a memory address depending on the instruction. FPU circuits 809 perform floating-point arithmetic. The width of the execution unit(s) circuitry 762 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

In this description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes an apparatus comprising: a memory side cache to store a portion of data to be stored in a main memory; and logic circuitry to determine whether to allocate a portion of the memory side cache for use by a device, wherein a remaining portion of the memory side cache is to be used by a processor, wherein the allocated portion of the memory side cache is to be reallocated for use by the processor in response to a determination that the allocated portion of the memory side cache is no longer to be used by the device. Example 2 includes the apparatus of example 1, wherein all traffic directed to the main memory is to be transmitted through the memory side cache. Example 3 includes the apparatus of example 1, wherein the logic circuitry is to determine whether to allocate the portion of the memory side cache based at least in part on a class of service associated with the device.

Example 4 includes the apparatus of example 1, wherein the logic circuitry is to determine whether to allocate the portion of the memory side cache based at least in part on a Normalized Bandwidth Saving (NBS) determination. Example 5 includes the apparatus of example 4, wherein the NBS determination is to differentiate between use of one or more buffers in the memory side cache by the processor versus the device. Example 6 includes the apparatus of example 1, further comprising memory to store a table, wherein the table is to store information regarding per device resource size and per device resource utilization. Example 7 includes the apparatus of example 6, wherein the logic circuitry is to cause an update to the table after each allocation of the memory side cache. Example 8 includes the apparatus of example 1, wherein the logic circuitry is to determine whether to allocate the portion of the memory side cache based at least in part on a status of a battery life mode. Example 9 includes the apparatus of example 1, wherein the allocated portion of the memory side cache comprises one or more buffers.

Example 10 includes the apparatus of example 1, wherein the logic circuitry is to determine whether to allocate the portion of the memory side cache based at least in part on buffer annotation information. Example 11 includes the apparatus of example 10, wherein the buffer annotation information is to be provided to the logic circuitry by the device. Example 12 includes the apparatus of example 10, wherein the buffer annotation information is to be provided to the logic circuitry by a device driver of the device. Example 13 includes the apparatus of example 1, wherein the logic circuitry is to be coupled between the memory side cache and a main memory fabric.

Example 14 includes the apparatus of example 1, wherein the determination that the allocated portion of the memory side cache is no longer to be used by the device is to be made based at least in part on a counter value or a timer. Example 15 includes the apparatus of example 1, wherein the device is to communicate with the memory side cache via a main memory fabric. Example 16 includes the apparatus of example 1, wherein a System on Chip comprises the logic circuitry, the memory side cache, and the device. Example 17 includes the apparatus of example 1, wherein the device comprises one of: graphics logic, media logic, a Vision Processing Unit (VPU), Input/Output (IO) logic, and an Infrastructure Processing Unit (IPU).

Example 18 includes one or more non-transitory computer-readable media comprising one or more instructions that when executed on a processor configure the processor to perform one or more operations to: a memory side cache to store a portion of data to be stored in a main memory; and logic circuitry to determine whether to allocate a portion of the memory side cache for use by a device, wherein a remaining portion of the memory side cache is to be used by a processor, wherein the allocated portion of the memory side cache is to be reallocated for use by the processor in response to a determination that the allocated portion of the memory side cache is no longer to be used by the device. Example 19 includes the one or more non-transitory computer-readable media of example 18, further comprising one or more instructions that when executed on the one processor configure the processor to perform one or more operations to cause all traffic directed to the main memory to be transmitted through the memory side cache. Example 20 includes the one or more non-transitory computer-readable media of example 18, further comprising one or more instructions that when executed on the one processor configure the processor to perform one or more operations to cause the logic circuitry to determine whether to allocate the portion of the memory side cache based at least in part on a class of service associated with the device.

Example 21 includes an apparatus comprising means to perform a method as set forth in any preceding example. Example 22 includes machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

Further, while various embodiments described herein may use the term System-on-a-Chip or System-on-Chip (“SoC” or “SOC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system may have one or more processors (e.g., one or more processor cores) and associated circuitry (e.g., I/O circuitry, power delivery circuitry, etc.) arranged in a disaggregated collection of discrete dies, tiles, and/or chiplets (e.g., one or more discrete processor core die arranged adjacent to one or more other die such as a memory die, I/O die, etc.). In such disaggregated devices and systems, the various dies, tiles, and/or chiplets may be physically and/or electrically coupled together by a package structure including, for example, various packaging substrates, interposers, active interposers, photonic interposers, interconnect bridges, and the like. The disaggregated collection of discrete dies, tiles, and/or chiplets may also be part of a System-on-Package (“SoP”).

In some embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a memory side cache to store a portion of data to be stored in a main memory; and
logic circuitry to determine whether to allocate a portion of the memory side cache for use by a device, wherein a remaining portion of the memory side cache is to be used by a processor,
wherein the allocated portion of the memory side cache is to be reallocated for use by the processor in response to a determination that the allocated portion of the memory side cache is no longer to be used by the device.

2. The apparatus of claim 1, wherein all traffic directed to the main memory is to be transmitted through the memory side cache.

3. The apparatus of claim 1, wherein the logic circuitry is to determine whether to allocate the portion of the memory side cache based at least in part on a class of service associated with the device.

4. The apparatus of claim 1, wherein the logic circuitry is to determine whether to allocate the portion of the memory side cache based at least in part on a Normalized Bandwidth Saving (NBS) determination.

5. The apparatus of claim 4, wherein the NBS determination is to differentiate between use of one or more buffers in the memory side cache by the processor versus the device.

6. The apparatus of claim 1, further comprising memory to store a table, wherein the table is to store information regarding per device resource size and per device resource utilization.

7. The apparatus of claim 6, wherein the logic circuitry is to cause an update to the table after each allocation of the memory side cache.

8. The apparatus of claim 1, wherein the logic circuitry is to determine whether to allocate the portion of the memory side cache based at least in part on a status of a battery life mode.

9. The apparatus of claim 1, wherein the allocated portion of the memory side cache comprises one or more buffers.

10. The apparatus of claim 1, wherein the logic circuitry is to determine whether to allocate the portion of the memory side cache based at least in part on buffer annotation information.

11. The apparatus of claim 10, wherein the buffer annotation information is to be provided to the logic circuitry by the device.

12. The apparatus of claim 10, wherein the buffer annotation information is to be provided to the logic circuitry by a device driver of the device.

13. The apparatus of claim 1, wherein the logic circuitry is to be coupled between the memory side cache and a main memory fabric.

14. The apparatus of claim 1, wherein the determination that the allocated portion of the memory side cache is no longer to be used by the device is to be made based at least in part on a counter value or a timer.

15. The apparatus of claim 1, wherein the device is to communicate with the memory side cache via a main memory fabric.

16. The apparatus of claim 1, wherein a System on Chip comprises the logic circuitry, the memory side cache, and the device.

17. The apparatus of claim 1, wherein the device comprises one of: graphics logic, media logic, a Vision Processing Unit (VPU), Input/Output (IO) logic, and an Infrastructure Processing Unit (IPU).

18. One or more non-transitory computer-readable media comprising one or more instructions that when executed on a processor configure the processor to perform one or more operations to:
a memory side cache to store a portion of data to be stored in a main memory; and
logic circuitry to determine whether to allocate a portion of the memory side cache for use by a device, wherein a remaining portion of the memory side cache is to be used by a processor,
wherein the allocated portion of the memory side cache is to be reallocated for use by the processor in response to a determination that the allocated portion of the memory side cache is no longer to be used by the device.

19. The one or more non-transitory computer-readable media of claim 18, further comprising one or more instructions that when executed on the one processor configure the processor to perform one or more operations to cause all traffic directed to the main memory to be transmitted through the memory side cache.

20. The one or more non-transitory computer-readable media of claim 18, further comprising one or more instructions that when executed on the one processor configure the processor to perform one or more operations to cause the logic circuitry to determine whether to allocate the portion of the memory side cache based at least in part on a class of service associated with the device.
